(19) United States
(12) Patent Application Publication
(10) Pub. No.: US 2023/0237584 A1
(43) Pub. Date: Jul. 27, 2023

(54) SYSTEMS AND METHODS FOR EVALUATING VEHICLE INSURANCE CLAIMS

(71) Applicant: BlueOwl, LLC, San Francisco, CA (US)

(72) Inventors: Kenneth Jason Sanchez, San Francisco, CA (US); Holger Struppek, San Francisco, CA (US); Scott Howard, Emeryville, CA (US); John Minichiello, Monticello, FL (US)

(21) Appl. No.: 17/084,124

(22) Filed: Oct. 29, 2020

(51) Int. Cl. G06Q 40/08; G07C 5/00; G07C 5/08; G06T 7/00

(52) U.S. Cl. CPC G06Q 40/08; G07C 5/008; G07C 5/0841; G06T 7/001

(57) ABSTRACT

Method and system for evaluating vehicle insurance claims. For example, the method includes collecting pre-accident images of a vehicle before one or more accidents, collecting telematics data of the vehicle during the one or more accidents, determining predicted post-accident images of the vehicle based upon the pre-accident images and the telematics data after the one or more accidents, receiving submitted post-accident images for vehicle insurance claims associated with the vehicle, comparing the predicted post-accident images with the submitted post-accident images, and determining whether frauds have been committed in the vehicle insurance claims based upon the comparison of the predicted post-accident images with the submitted post-accident images.

### FIELD OF THE DISCLOSURE

Some embodiments of the present disclosure are directed to evaluating vehicle insurance claims. More particularly, certain embodiments of the present disclosure provide methods and systems for evaluating a vehicle insurance claim by comparing predicted and submitted images of a vehicle following an accident. Merely by way of example, the present disclosure has been applied to determining whether fraud has been committed in the vehicle insurance claim based upon the comparison of the predicted and submitted images. But it would be recognized that the present disclosure has much broader range of applicability.

### BACKGROUND OF THE DISCLOSURE

In vehicle insurance, the ability to accurately validate facts related to a claim is paramount. For a typical vehicle insurance claim, a claims adjuster usually investigates an accident, determines who is at fault, and recommends how much an insurance company will pay for damages. Economies of scale and improved efficiencies can be obtained by not having the claims adjuster perform any physical inspections when a claim arises. Hence, there remains a need to develop better techniques to verify that a vehicle insurance claim is legitimate.

### BRIEF SUMMARY OF THE DISCLOSURE

Some embodiments of the present disclosure are directed to evaluating vehicle insurance claims. More particularly, certain embodiments of the present disclosure provide methods and systems for evaluating a vehicle insurance claim by comparing predicted and submitted images of a vehicle following an accident. Merely by way of example, the present disclosure has been applied to determining whether fraud has been committed in the vehicle insurance claim based upon the comparison of the predicted and submitted images. But it would be recognized that the present disclosure has much broader range of applicability.

According to some embodiments, a method for evaluating vehicle insurance claims includes collecting one or more pre-accident images of a vehicle before one or more accidents associated with the vehicle and collecting telematics data of the vehicle during the one or more accidents associated with the vehicle. Also, the method includes determining one or more predicted post-accident images of the vehicle based at least in part upon the one or more pre-accident images and the telematics data after the one or more accidents associated with the vehicle. Additionally, the method includes receiving one or more submitted post-accident images for one or more vehicle insurance claims associated with the vehicle and comparing the one or more predicted post-accident images with the one or more submitted post-accident images. Moreover, the method includes determining whether one or more frauds have been committed in the one or more vehicle insurance claims based at least in part upon the comparison of the one or more predicted post-accident images with the one or more submitted post-accident images.

According to certain embodiments, a computing device for evaluating vehicle insurance claims includes one or more processors and a memory that stores instructions for execution by the one or more processors. The instructions, when executed, cause the one or more processors to collect one or more pre-accident images of a vehicle before one or more accidents associated with the vehicle and collect telematics data of the vehicle during the one or more accidents associated with the vehicle. Also, the instructions, when executed, cause the one or more processors to determine one or more predicted post-accident images of the vehicle based at least in part upon the one or more pre-accident images and the telematics data after the one or more accidents associated with the vehicle. Additionally, the instructions, when executed, cause the one or more processors to receive one or more submitted post-accident images for one or more vehicle insurance claims associated with the vehicle and compare the one or more predicted post-accident images with the one or more submitted post-accident images. Moreover, the instructions, when executed, cause the one or more processors to determine whether one or more frauds have been committed in the one or more vehicle insurance claims based at least in part upon the comparison of the one or more predicted post-accident images with the one or more submitted post-accident images.

According to some embodiments, a non-transitory computer-readable medium stores instructions for evaluating vehicle insurance claims. The instructions are executed by one or more processors of a computing device. The non-transitory computer-readable medium includes instructions to collect one or more pre-accident images of a vehicle before one or more accidents associated with the vehicle and collect telematics data of the vehicle during the one or more accidents associated with the vehicle. Also, the non-transitory computer-readable medium includes instructions to determine one or more predicted post-accident images of the vehicle based at least in part upon the one or more pre-accident images and the telematics data after the one or more accidents associated with the vehicle. Additionally, the non-transitory computer-readable medium includes instructions to receive one or more submitted post-accident images for one or more vehicle insurance claims associated with the vehicle and compare the one or more predicted post-accident images with the one or more submitted post-accident images. Moreover, the non-transitory computer-readable medium includes instructions to determine whether one or more frauds have been committed in the one or more vehicle insurance claims based at least in part upon the comparison of the one or more predicted post-accident images with the one or more submitted post-accident images.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified method for evaluating vehicle insurance claims according to certain embodiments of the present disclosure.

FIG. 2 is a simplified method for evaluating vehicle insurance claims according to some embodiments of the present disclosure.

FIG. 3 is a simplified system for evaluating vehicle insurance claims according to certain embodiments of the present disclosure.

### DETAILED DESCRIPTION OF THE DISCLOSURE

Some embodiments of the present disclosure are directed to evaluating vehicle insurance claims. More particularly, certain embodiments of the present disclosure provide methods and systems for evaluating a vehicle insurance claim by comparing predicted and submitted images of a vehicle following an accident. Merely by way of example, the present disclosure has been applied to determining whether fraud has been committed in the vehicle insurance claim based upon the comparison of the predicted and submitted images. But it would be recognized that the present disclosure has much broader range of applicability.

### I. One or More Methods for Evaluating Vehicle Insurance Claims According to Certain Embodiments

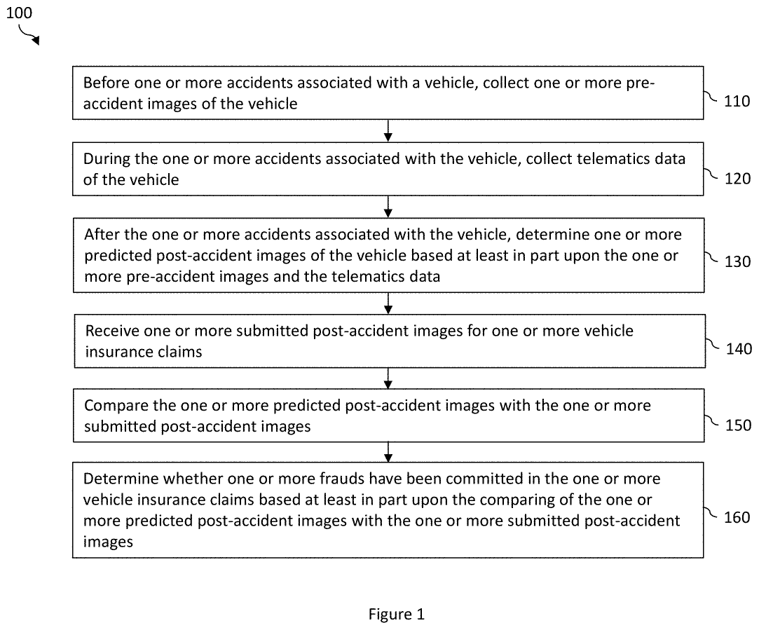

FIG. 1 is a simplified method for evaluating vehicle insurance claims according to certain embodiments of the present disclosure. This diagram is merely an example, which should not unduly limit the scope of the claims. One of ordinary skill in the art would recognize many variations, alternatives, and modifications. The method 100 includes process 110 for collecting pre-accident images of a vehicle, process 120 for collecting telematics data of the vehicle, process 130 for determining predicted post-accident images of the vehicle, process 140 for receiving submitted post-accident images of the vehicle, process 150 for comparing the predicted post-accident images with the submitted post-accident images, and process 160 for determining whether fraud has been committed in a vehicle insurance claim associated with the vehicle based upon the comparison of the predicted post-accident images and the submitted post-accident images. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 110, before the occurrence of one or more accidents associated with the vehicle, one or more pre-accident images of the vehicle are collected according to some embodiments. For example, the one or more pre-accident images are collected using an image capturing device (e.g., a mobile device, a standalone camera) associated with an operator (e.g., driver) of the vehicle. In various embodiments, the image capturing device uses one or more orientations, zoom levels, effects, etc., to capture the one or more pre-accident images of the vehicle. According to some embodiments, the one or more pre-accident images depict any pre-existing damages on the vehicle prior to an accident.

At the process 120, during the one or more accidents associated with the vehicle, the telematics data of the vehicle are collected according to certain embodiments. According to some embodiments, the telematics data are collected from one or more sensors associated with the vehicle. For example, the one or more sensors include any type and number of accelerometers, gyroscopes, magnetometers, location sensors (e.g., GPS sensors), tilt sensors, yaw rate sensors, speedometers, steering angle sensors, brake sensors, proximity detectors, and/or any other suitable sensors. In certain embodiments, the one or more sensors are part of the vehicle. In some embodiments, the one or more sensors are part of the mobile device associated with the operator of the vehicle that is communicatively connected to the vehicle.

According to various embodiments, the telematics data indicate the state the vehicle incident to the one or more accidents. For example, the telematics data indicate various vehicle operating conditions immediately prior to and during the one or more accidents including braking (e.g., excessive braking, sudden braking), acceleration (e.g., rapid acceleration, prolonged acceleration), cornering (e.g., sharp turning, swerving), speeding, lane changing, tailgating, idling, and/or other relevant vehicle operating conditions.

At the process 130, after the occurrence of the one or more accidents associated with the vehicle, one or more predicted post-accident images of the vehicle are determined based at least in part upon the one or more pre-accident images and the telematics data according to some embodiments. For example, the telematics data are analyzed along with the one or more pre-accident images to determine various damages that will be incurred by the vehicle as a result of the one or more accidents. As an example, the one or more predicted post-accident images depict an amount and extent of damages that will be incurred by the vehicle from the one or more accidents. According to certain embodiments, metadata are included in the one or more predicted post-accident images. For example, the metadata include geographic location information, date information, etc.

At the process 140, one or more submitted post-accident images are received for one or more vehicle insurance claims associated with the vehicle according to certain embodiments. For example, the one or more submitted post-accident images are collected using the image capturing device associated with the operator of the vehicle after the occurrence of the one or more accidents. As an example, the one or more submitted post-accident images are collected on-site after the occurrence of the one or more accidents. According to some embodiments, metadata are included in the one or more submitted post-accident images as they are captured. For example, the metadata include geographic location information, date information, etc. According to certain embodiments, the one or more submitted post-accident images show the condition of the vehicle following the one or more accidents (e.g., damaged and/or undamaged parts of the vehicle). In various embodiments, the one or more vehicle insurance claims include additional information such as insurance policy information (e.g., policy holder, policy number), vehicle information (e.g., year/model/make of the vehicle), police report information, etc.

At the process 150, the one or more predicted post-accident images are compared with the one or more submitted post-accident images according to certain embodiments. For example, the comparison determines whether the one or more submitted post-accident images match the one or more predicted post-accident images in order to support the one or more vehicle insurance claims. According to some embodiments, the comparison includes wrapping (e.g., projecting) the one or more submitted post-accident images onto the one or more predicted post-accident images to determine if any damages overlap. According to certain embodiments, the comparison includes performing feature extractions, adaptive recognitions, annotations, etc. on the post-accident images to determine if the damaged and/or undamaged parts of the vehicle match one another in the one or more submitted post-accident images and the one or more predicted post-accident images. According to some embodiments, the comparison includes analyzing the one or more submitted post-accident images to determine whether these images are authentic or have been modified. For example, any suitable image analysis techniques (e.g., image forensic techniques, edge detection techniques, image error level analyses, colored layer analyses, compression analyses) can be used to identify whether or not a submitted post-accident image has been tampered with (e.g., digitally modified via a graphics editing software).

According to certain embodiments, the comparison includes comparing the metadata associated with the post-accident images. For example, one or more first sets of metadata from the one or more predicted post-accident images and one or more second sets of metadata from the one or more submitted post-accident images are extracted and compared with. As an example, the extraction includes extracting dates and/or geographic locations from the one or more predicted post-accident images and the one or more submitted post-accident images. In some embodiments, comparing the metadata includes determining whether the date and/or geographic location indicated by the metadata of one or more submitted post-accident images coincide with the date and/or geographic location indicated by the metadata of the one or more predicted post-accident images. In certain embodiments, any differences between the dates and/or geographic locations are calculated and converted into a corresponding weight. For example, if the metadata of the one or more submitted post-accident images show that the date and/or geographic location are within a certain threshold (e.g., within a particular time period and/or within a particular radius) of the date and/or geographic location of the metadata in the one or more predicted post-accident images, then a favorable weight is assigned to the one or more submitted post-accident images.

At the process 160, a determination is made on whether one or more frauds have been committed in the one or more vehicle insurance claims based at least in part upon the comparion of the one or more predicted post-accident images with the one or more submitted post-accident images according to some embodiments. For example, if the comparison indicates that the one or more submitted post-accident images and the one or more predicted post-accident images are identical or similar (e.g., within allowable deviation), then it will be determined that no fraud has been committed in the one or more vehicle insurance claims. As an example, if the comparison indicates that one or more submitted post-accident images are different from the one or more predicted post-accident images (e.g., the one or more submitted post-accident images include pre-existing damages to the vehicle or different types of damages than what are predicted), then will be determined that potential fraud has been committed in the one or more vehicle insurance claims.

According to certain embodiments, fraud is designated in the one or more vehicle insurance claims if a comparison of the one or more first sets of metadata and the one or more second sets of metadata is above a given threshold (e.g., the difference between the date as indicated in the metadata of the one or more submitted post-accident images and the date as indicated in the metadata of the one or more predicted post-accident images exceeds a certain number of days). According to some embodiments, no fraud is designated in the one or more vehicle insurance claims if a comparison of the one or more first sets of metadata and the one or more second sets of metadata is below a given threshold (e.g., the difference between the geographic location as indicated in the metadata of the one or more submitted post-accident images and the geographic location as indicated in the metadata of the one or more predicted post-accident images is within a certain radius value).

In various embodiments, an overall assessment of fraudulent activities for the one or more vehicle insurance claims is generated and displayed to one or more users. For example, the overall assessment is sent to the mobile device associated with the operator of vehicle for display. As an example, if fraud has been detected in the one or more vehicle insurance claims based upon the comparison of the one or more submitted post-accident images and the one or more predicted post-accident images, then a notification is sent to one or more insurance employees indicating that the one or more submitted post-accident image need further evaluation (e.g., manual review).

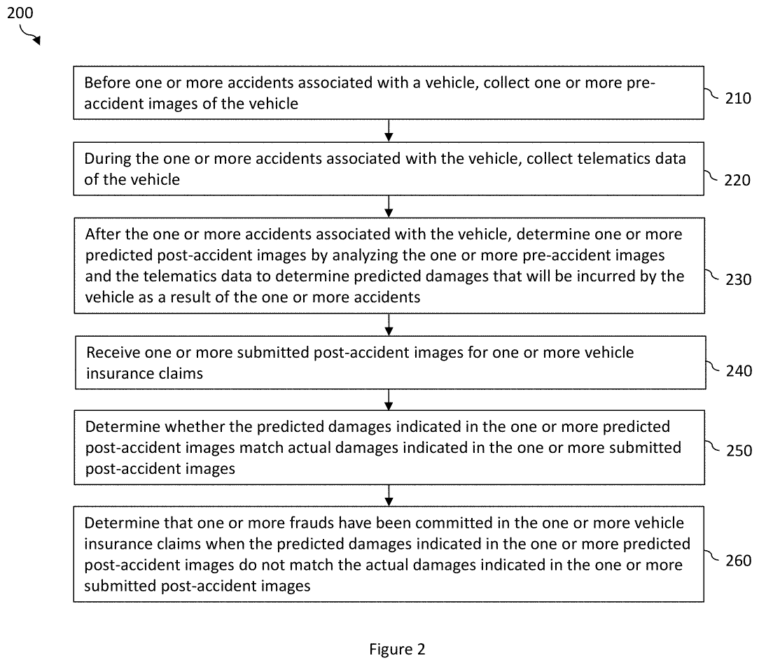

FIG. 2 is a simplified method for evaluating vehicle insurance claims according to some embodiments of the present disclosure. This diagram is merely an example, which should not unduly limit the scope of the claims. One of ordinary skill in the art would recognize many variations, alternatives, and modifications. The method 200 includes process 210 for collecting pre-accident images of a vehicle, process 220 for collecting telematics data of the vehicle, process 230 for analyzing pre-accident images and the telematics data, process 240 for receiving submitted post-accident images of the vehicle, process 250 for determining whether predicted damages match actual damages, and process 260 for determining fraud in a vehicle insurance claim based upon whether the predicted damages match the actual damages. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 210, before the occurrence of one or more accidents associated with the vehicle, one or more pre-accident images of the vehicle are collected according to some embodiments. For example, the one or more pre-accident images are collected using an image capturing device (e.g., camera) associated with an operator or driver of the vehicle.

At the process 220, during the one or more accidents associated with the vehicle, the telematics data of the vehicle are collected according to certain embodiments. According to some embodiments, the telematics data are collected from one or more sensors (e.g., accelerometers, gyroscopes, magnetometers, GPS sensors, tilt sensors, yaw rate sensors, speedometers, steering angle sensors, brake sensors, proximity detectors, etc.) associated with the vehicle. In certain embodiments, the one or more sensors are part of the vehicle, while in some embodiments, the one or more sensors are part of a computing device (e.g., mobile device) associated with the operator of the vehicle that is communicatively connected to the vehicle.

According to various embodiments, the telematics data indicate the state the vehicle immediately prior to and during the one or more accidents. For example, the telematics data indicate various vehicle operating conditions such as braking, acceleration, cornering, speeding, lane changing, tailgating, idling, etc.

At the process 230, after the occurrence of the one or more accidents associated with the vehicle, the one or more pre-accident images and the telematics data are analyzed to determine one or more predicted post-accident images indicating predicted damages that will be incurred by the vehicle as a result of the one or more accidents according to some embodiments. As an example, the predicted damages include a type of vehicle damage (e.g., body/frame damage, windshield damage, wheel damage, door damage, interior damage, etc.), a severity of vehicle damage (e.g., dents, cracks, punctures, tears, bends, bumps, abrasions, corrosions, etc.), and/or a location of vehicle damage (e.g., front-end, rear-end, side panel, etc.). According to certain embodiments, metadata (e.g., date information, geographic location information) are included in the one or more predicted post-accident images.

At the process 240, one or more submitted post-accident images are received for one or more vehicle insurance claims associated with the vehicle according to certain embodiments. For example, the one or more submitted post-accident images are collected using the image capturing device associated with the operator of the vehicle after the occurrence of the one or more accidents. According to some embodiments, metadata (e.g., date information, geographic location information) are included in the one or more submitted post-accident images as they are captured.

At the process 250, a determination is made on whether the predicted damages indicated in the one or more predicted post-accident images match actual damages indicated in the one or more submitted post-accident images according to some embodiments. For example, the one or more submitted post-accident images are compared with the one or more predicted post-accident images to determine if the predicted and actual damages are identical or similar. In various embodiments, the comparison involves any suitable image analysis techniques including feature extractions, adaptive recognitions, annotations, etc.

At the process 260, a determination is made that one or more frauds have been committed in the one or more vehicle insurance claims when the predicted damages indicated in the one or more predicted post-accident images do not match the actual damages indicated in the one or more submitted post-accident images according to certain embodiments. In some embodiments, a determination is made that no fraud has been committed in the one or more vehicle insurance claims when the predicted damages indicated in the one or more predicted post-accident images match the actual damages indicated in the one or more submitted post-accident images. According to various embodiments, if fraud has been detected in the one or more vehicle insurance claims, then a notification is sent to one or more insurance employees indicating that the one or more submitted post-accident image need further evaluation (e.g., manual review).

According to certain embodiments, analyzing the one or more pre-accident images and the telematics data to determine the predicted damages in the process 230 as shown in FIG. 2 is performed as part of the process 130 as shown in FIG. 1. According to some embodiments, determining whether the predicted damages match the actual damages in the process 250 as shown in FIG. 2 is performed as part of the process 150 as shown in FIG. 1.

### II. One or More Systems for Evaluating Vehicle Insurance Claims According to Certain Embodiments

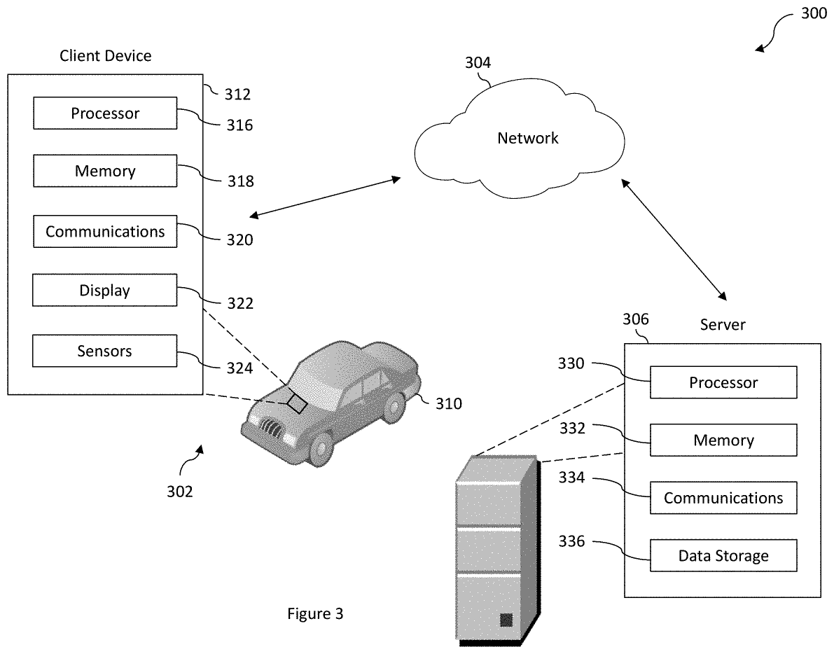

FIG. 3 is a simplified system for evaluating vehicle insurance claims according to certain embodiments of the present disclosure. This diagram is merely an example, which should not unduly limit the scope of the claims. One of ordinary skill in the art would recognize many variations, alternatives, and modifications. The system 300 includes a vehicle system 302, a network 304, and a server 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the system 300 is used to implement the method 100 and/or the method 200. According to certain embodiments, the vehicle system 302 includes a vehicle 310 and a client device 312 associated with the vehicle 310. For example, the client device 312 is an on-board computer embedded or located in the vehicle 310. As an example, the client device 312 is a mobile device (e.g., a smartphone) that is connected (e.g., via wired or wireless links) to the vehicle 310. As an example, the client device 312 includes a processor 316 (e.g., a central processing unit (CPU), a graphics processing unit (GPU)), a memory 318 (e.g., random-access memory (RAM), read-only memory (ROM), flash memory), a communications unit 320 (e.g., a network transceiver), a display unit 322 (e.g., a touchscreen), and one or more sensors 324 (e.g., an accelerometer, a gyroscope, a magnetometer, a GPS sensor).

In some embodiments, the vehicle 310 is operated by a user. In certain embodiments, multiple vehicles 310 exist in the system 300 which are operated by respective users. As an example, the one or more sensors 324 monitor the vehicle 310 by collecting data (e.g., speed, acceleration, braking, location, engine status). According to some embodiments, the data are collected immediately prior to and during an accident associated with the vehicle 310. According to certain embodiments, the data are continuously during the operation of the vehicle 310. In various embodiments, the collected data represent the telematics data in the method 100 and/or the method 200.

According to some embodiments, the collected data are stored in the memory 318 before being transmitted to the server 306 using the communications unit 322 via the network 304 (e.g., via a local area network (LAN), a wide area network (WAN), the Internet). In certain embodiments, the collected data are transmitted directly to the server 306 via the network 304. In some embodiments, the collected data are transmitted to the server 306 via a third party. For example, a data monitoring system stores any and all data collected by the one or more sensors 324 and transmits those data to the server 306 via the network 304 or a different network.

According to certain embodiments, the server 306 includes a processor 330 (e.g., a microprocessor, a microcontroller), a memory 332, a communications unit 334 (e.g., a network transceiver), and a data storage 336 (e.g., one or more databases). In some embodiments, the server 306 is a single server, while in certain embodiments, the server 306 includes a plurality of servers with distributed processing. In FIG. 3, the data storage 336 is shown to be part of the server 306. In some embodiments, the data storage 336 is a separate entity coupled to the server 306 via a network such as the network 304. In certain embodiments, the server 306 includes various software applications stored in the memory 332 and executable by the processor 330. For example, these software applications include specific programs, routines, or scripts for performing functions associated with the method 100 and/or the method 200. As an example, the software applications include general-purpose software applications for data processing, network communication, database management, web server operation, and/or other functions typically performed by a server.

According to various embodiments, the server 306 receives, via the network 304, the data collected by the one or more sensors 324 using the communications unit 334 and stores the data in the data storage 336. For example, the server 306 then processes the data to perform one or more processes of the method 100 and/or one or more processes of the method 200.

According to certain embodiments, an assessment of whether fraud has been committed in a vehicle insurance claim as determined in the method 100 and/or the method 200 is generated and transmitted to the client device 312, via the network 304, to be displayed to the user via the display unit 322.

In some embodiments, one or more processes of the method 100 and/or one or more processes of the method 200 are performed by the client device 312. For example, the processor 316 of the client device 312 processes the data collected by the one or more sensors 324 to perform one or more processes of the method 100 and/or one or more processes of the method 200.

### III. Examples of Certain Embodiments of the Present Disclosure

According to some embodiments, a method for evaluating vehicle insurance claims includes collecting one or more pre-accident images of a vehicle before one or more accidents associated with the vehicle and collecting telematics data of the vehicle during the one or more accidents associated with the vehicle. Also, the method includes determining one or more predicted post-accident images of the vehicle based at least in part upon the one or more pre-accident images and the telematics data after the one or more accidents associated with the vehicle. Additionally, the method includes receiving one or more submitted post-accident images for one or more vehicle insurance claims associated with the vehicle and comparing the one or more predicted post-accident images with the one or more submitted post-accident images. Moreover, the method includes determining whether one or more frauds have been committed in the one or more vehicle insurance claims based at least in part upon the comparison of the one or more predicted post-accident images with the one or more submitted post-accident images. For example, the method is implemented according to at least FIG. 1 and/or FIG. 2.

According to certain embodiments, a computing device for evaluating vehicle insurance claims includes one or more processors and a memory that stores instructions for execution by the one or more processors. The instructions, when executed, cause the one or more processors to collect one or more pre-accident images of a vehicle before one or more accidents associated with the vehicle and collect telematics data of the vehicle during the one or more accidents associated with the vehicle. Also, the instructions, when executed, cause the one or more processors to determine one or more predicted post-accident images of the vehicle based at least in part upon the one or more pre-accident images and the telematics data after the one or more accidents associated with the vehicle. Additionally, the instructions, when executed, cause the one or more processors to receive one or more submitted post-accident images for one or more vehicle insurance claims associated with the vehicle and compare the one or more predicted post-accident images with the one or more submitted post-accident images. Moreover, the instructions, when executed, cause the one or more processors to determine whether one or more frauds have been committed in the one or more vehicle insurance claims based at least in part upon the comparison of the one or more predicted post-accident images with the one or more submitted post-accident images. For example, the computing device is implemented according to at least FIG. 3.

According to some embodiments, a non-transitory computer-readable medium stores instructions for evaluating vehicle insurance claims. The instructions are executed by one or more processors of a computing device. The non-transitory computer-readable medium includes instructions to collect one or more pre-accident images of a vehicle before one or more accidents associated with the vehicle and collect telematics data of the vehicle during the one or more accidents associated with the vehicle. Also, the non-transitory computer-readable medium includes instructions to determine one or more predicted post-accident images of the vehicle based at least in part upon the one or more pre-accident images and the telematics data after the one or more accidents associated with the vehicle. Additionally, the non-transitory computer-readable medium includes instructions to receive one or more submitted post-accident images for one or more vehicle insurance claims associated with the vehicle and compare the one or more predicted post-accident images with the one or more submitted post-accident images. Moreover, the non-transitory computer-readable medium includes instructions to determine whether one or more frauds have been committed in the one or more vehicle insurance claims based at least in part upon the comparison of the one or more predicted post-accident images with the one or more submitted post-accident images. For example, the non-transitory computer-readable medium is implemented according to at least FIG. 1, FIG. 2 and/or FIG. 3.

### IV. Examples of Machine Learning According to Certain Embodiments

According to some embodiments, a processor or a processing element may be trained using supervised machine learning and/or unsupervised machine learning, and the machine learning may employ an artificial neural network, which, for example, may be a convolutional neural network, a recurrent neural network, a deep learning neural network, a reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

According to certain embodiments, machine learning programs may be trained by inputting sample data sets or certain data into the programs, such as images, object statistics and information, historical estimates, and/or actual repair costs. The machine learning programs may utilize deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing. The machine learning programs may also include natural language processing, semantic analysis, automatic reasoning, and/or other types of machine learning.

According to some embodiments, supervised machine learning techniques and/or unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. In unsupervised machine learning, the processing element may need to find its own structure in unlabeled example inputs.

### V. Additional Considerations According to Certain Embodiments

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, while the embodiments described above refer to particular features, the scope of the present disclosure also includes embodiments having different combinations of features and embodiments that do not include all of the described features. As an example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

1. A method for evaluating vehicle insurance claims, the method comprising:
before one or more accidents associated with a vehicle, collecting, by a computing device, one or more pre-accident images of the vehicle;
during the one or more accidents associated with the vehicle, collecting, by the computing device, telematics data of the vehicle;
after the one or more accidents associated with the vehicle, determining, by the computing device, one or more predicted post-accident images of the vehicle based at least in part upon the one or more pre-accident images and the telematics data;
receiving, by the computing device, one or more submitted post-accident images for one or more vehicle insurance claims associated with the vehicle;
comparing, by the computing device, the one or more predicted post-accident images with the one or more submitted post-accident images; and
determining, by the computing device, whether one or more frauds have been committed in the one or more vehicle insurance claims based at least in part upon the comparing of the one or more predicted post-accident images with the one or more submitted post-accident images.

2. The method of claim 1, wherein the comparing of the one or more predicted post-accident images with the one or more submitted post-accident images includes:
extracting one or more first sets of metadata based at least in part upon the one or more predicted post-accident images;
extracting one or more second sets of metadata based at least in part upon the one or more submitted post-accident images; and
comparing the one or more first sets of metadata with the one or more second sets of metadata.

3. The method of claim 2, wherein the determining of whether the one or more frauds have been committed in the one or more vehicle insurance claims includes determining whether the one or more frauds have been committed by comparing the one or more first sets of metadata with the one or more second sets of metadata.

4. The method of claim 1, wherein the determining of the one or more predicted post-accident images of the vehicle includes analyzing the one or more pre-accident images and the telematics data to determine predicted damages that will be incurred by the vehicle as a result of the one or more accidents.

5. The method of claim 4, wherein the comparing of the one or more predicted post-accident images with the one or more submitted post-accident images includes determining whether the predicted damages indicated in the one or more predicted post-accident images match actual damages indicated in the one or more submitted post-accident images.

6. The method of claim 5, wherein the determining of whether the one or more frauds have been committed in the one or more vehicle insurance claims includes determining that the one or more frauds have been committed when the predicted damages indicated in the one or more predicted post-accident images do not match the actual damages indicated in the one or more submitted post-accident images.

7. The method of claim 4, wherein the predicted damages include one or more of a type of vehicle damage, a severity of vehicle damage, and a location of vehicle damage.

8. A computing device for evaluating vehicle insurance claims, the computing device comprising:
one or more processors; and
a memory storing instructions that, when executed by the one or more processors, cause the one or more processors to:
before one or more accidents associated with a vehicle, collect one or more pre-accident images of the vehicle;
during the one or more accidents associated with the vehicle, collect telematics data of the vehicle;
after the one or more accidents associated with the vehicle, determine one or more predicted post-accident images of the vehicle based at least in part upon the one or more pre-accident images and the telematics data;
receive one or more submitted post-accident images for one or more vehicle insurance claims associated with the vehicle;
compare the one or more predicted post-accident images with the one or more submitted post-accident images; and
determine whether one or more frauds have been committed in the one or more vehicle insurance claims based at least in part upon comparing the one or more predicted post-accident images with the one or more submitted post-accident images.

9. The computing device of claim 8, wherein the instructions that cause the one or more processors to compare the one or more predicted post-accident images with the one or more submitted post-accident images further comprise instructions that cause the one or more processors to:
extract one or more first sets of metadata based at least in part upon the one or more predicted post-accident images;
extract one or more second sets of metadata based at least in part upon the one or more submitted post-accident images; and
compare the one or more first sets of metadata with the one or more second sets of metadata.

10. The computing device of claim 9, wherein the instructions that cause the one or more processors to determine whether the one or more frauds have been committed in the one or more vehicle insurance claims further comprise instructions that cause the one or more processors to determine whether the one or more frauds have been committed by comparing the one or more first sets of metadata with the one or more second sets of metadata.

11. The computing device of claim 8, wherein the instructions that cause the one or more processors to determine the one or more predicted post-accident images of the vehicle further comprise instructions that cause the one or more processors to analyze the one or more pre-accident images and the telematics data to determine predicted damages that will be incurred by the vehicle as a result of the one or more accidents.

12. The computing device of claim 11, wherein the instructions that cause the one or more processors to compare the one or more predicted post-accident images with the one or more submitted post-accident images further comprise instructions that cause the one or more processors to determine whether the predicted damages indicated in the one or more predicted post-accident images match actual damages indicated in the one or more submitted post-accident images.

13. The computing device of claim 12, wherein the instructions that cause the one or more processors to determine whether the one or more frauds have been committed in the one or more vehicle insurance claims further comprise instructions that cause the one or more processors to determine that the one or more frauds have been committed when the predicted damages indicated in the one or more predicted post-accident images do not match the actual damages indicated in the one or more submitted post-accident images.

14. The computing device of claim 11, wherein the predicted damages include one or more of a type of vehicle damage, a severity of vehicle damage, and a location of vehicle damage.

15. A non-transitory computer-readable medium storing instructions for evaluating vehicle insurance claims, the instructions when executed by one or more processors of a computing device cause the computing device to:
before one or more accidents associated with a vehicle, collect one or more pre-accident images of the vehicle;
during the one or more accidents associated with the vehicle, collect telematics data of the vehicle;
after the one or more accidents associated with the vehicle, determine one or more predicted post-accident images of the vehicle based at least in part upon the one or more pre-accident images and the telematics data;
receive one or more submitted post-accident images for one or more vehicle insurance claims associated with the vehicle;
compare the one or more predicted post-accident images with the one or more submitted post-accident images; and
determine whether one or more frauds have been committed in the one or more vehicle insurance claims based at least in part upon comparing the one or more predicted post-accident images with the one or more submitted post-accident images.

16. The non-transitory computer-readable medium of claim 15, wherein the instructions when executed by the one or more processors that cause the computing device to compare the one or more predicted post-accident images with the one or more submitted post-accident images further cause the computing device to:
extract one or more first sets of metadata based at least in part upon the one or more predicted post-accident images;
extract one or more second sets of metadata based at least in part upon the one or more submitted post-accident images; and
compare the one or more first sets of metadata with the one or more second sets of metadata.

17. The non-transitory computer-readable medium of claim 16, wherein the instructions when executed by the one or more processors that cause the computing device to determine whether the one or more frauds have been committed in the one or more vehicle insurance claims further cause the computing device to determine whether the one or more frauds have been committed by comparing the one or more first sets of metadata with the one or more second sets of metadata.

18. The non-transitory computer-readable medium of claim 15, wherein the instructions when executed by the one or more processors that cause the computing device to determine the one or more predicted post-accident images of the vehicle further cause the computing device to analyze the one or more pre-accident images and the telematics data to determine predicted damages that will be incurred by the vehicle as a result of the one or more accidents.

19. The non-transitory computer-readable medium of claim 18, wherein the instructions when executed by the one or more processors that cause the computing device to compare the one or more predicted post-accident images with the one or more submitted post-accident images further cause the computing device to determine whether the predicted damages indicated in the one or more predicted post-accident images match actual damages indicated in the one or more submitted post-accident images.

20. The non-transitory computer-readable medium of claim 19, wherein the instructions when executed by the one or more processors that cause the computing device to determine whether the one or more frauds have been committed in the one or more vehicle insurance claims further cause the computing device to determine that the one or more frauds have been committed when the predicted damages indicated in the one or more predicted post-accident images do not match the actual damages indicated in the one or more submitted post-accident images.
